(19) United States
(12) Patent Application Publication
(10) Pub. No.: US 2008/0111822 A1
(43) Pub. Date: May 15, 2008

(54) METHOD AND SYSTEM FOR PRESENTING VIDEO

(75) Inventors: STEVEN HOROWITZ, OAKLAND, CA (US); TOMI BLINNIKKA, BERKELEY, CA (US); LLOYD BRAUN, SANTA MONICA, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: YAHOO, INC.!, SUNNYVALE, CA (US)

(21) Appl. No.: 11/534,591

(22) Filed: Sep. 22, 2006

(51) Int. Cl. H04N 5/45

(52) U.S. Cl. 345/530

(57) ABSTRACT

Methods and systems of presenting video on a computer display having a visible display area are hereby disclosed. At least one video input is received from a video source. A video corresponding to the video put is displayed in a viewing region of the display. The viewing region can be of a size that occupies a fractional portion of the visible display area. The video can be displayed in a translucent fashion so that the video is visible and so that other content displayed on the computer display is visible through the video. After a period of user inactivity, the video can be displayed in an opaque fashion so that other content displayed on the computer display is hidden under the video.

### BACKGROUND

1. Field

This disclosure relates to methods and systems for displaying video on a computer display.

2. General Background

The expansion of the Internet and the World Wide Web (“web”) has given computer users the enhanced ability to listen to and to watch various different forms of media through their computers. Such media can be in the form of audio music, music videos, and television programs, sporting events or any other form of audio or video media that a user wishes to watch or listen to. Media is now overwhelmingly being distributed through computer networks. Furthermore, users frequently access media via a personal computer, handheld devices, etc. However, users who view videos on a computer display generally have to play one video at a time. In addition, current systems for presenting video are not conducive to multitasking.

### SUMMARY

In one aspect, there is a method of presenting video on a display having a visible display area. A first video input from a first video source is received for display. A second video input from a second video source is received for display. A first video corresponding to the first video input is displayed in a first viewing region of the display. The first viewing region can be of a size that occupies a fractional portion of the visible display area, such as a video thumbnail. A second video corresponding to the second video input is displayed in a second viewing region of the display. The second viewing region can be of a size that occupies a fractional portion of the visible display area, such as a video thumbnail. The first video and the second video, when displayed in the viewing regions, being displayed in a translucent fashion so that both the first video and the second video are visible, and so that other content displayed on the computer display is visible through the first video and the second video. Other content displayed on the computer display can include a graphical user interface. The first video viewing region can be enlarged upon receiving a selection of the first viewing region from the user.

In a further aspect of the method, the degree of translucency can be adjustable. A command can be received to minimize the degree of translucency to opaque. A command can also be received to maximize the degree of translucency to transparent. Furthermore, the first video source and/or the second video source can be a streaming server configured to transmit video signals over a computer network.

In another aspect of the method, metadata can be extracted from the first video signal, and a command can be executed if the metadata matches a criterion associated with the user. The metadata can comprise closed caption data. The command can comprise enlarging the first viewing region, or increasing the volume of an audio portion associated with the first video signal. The closed caption data can be displayed in a separate user interface display. In addition, extracting metadata from the first video signal can comprise recognizing text embedded in a video image associated with the first video signal. In another aspect, extracting metadata from the first video signal can comprise recognizing audio associated with the first video signal.

In another aspect of the method, it is determined whether a change in the first video signal has occurred. The change can comprise a scene change associated with the video signal. In another aspect, the change can comprise a change in audio volume. A command can be executed if the change matches a criterion associated with the user. The command can comprise enlarging the first viewing region, or increasing the volume of an audio portion associated with the first video signal. Information related to the first video input can be displayed upon a user hovering over the first viewing region. In addition, a playback operation user interface can be displayed in relation to the first video input upon a user hovering over the first viewing region. In a further aspect, the first video input can be a prerecorded video, or a live video stream. Likewise, the second video input can be a prerecorded video, or a live video stream.

In another aspect, there is a system that presents video on a display having a visible display area. The system can comprise a computing device and a display. The computing device can receive a first video input from a first video source. The computing device can further receive a second video input from a second video source. The display can display a first video corresponding to the first video input. The first video can be displayed in a first viewing region. The first viewing region can be of a size that occupies a fractional portion of the visible display area. The display can be further configured to display a second video corresponding to the second video input. The video can be displayed in a second viewing region. The second viewing region can be of a size that occupies a fractional portion of the visible display area. The first video and the second video, when displayed in the viewing regions, can be displayed in a translucent fashion so that both the first video and the second video are visible. The other content being displayed on the display can be visible through the first video and the second video.

In another aspect, there is a user interface for presenting video on a display comprising a visible display area and a video thumbnail. The visible display area can be configured to display user interface elements. The video thumbnail can be displayed on the visible display area. The video thumbnail can display video with a first degree of translucency when the user does not interact with the video thumbnail such that the first degree of translucency permits other user interface elements to be visible through the video thumbnail. The video thumbnail can display video with a second degree of translucency when the user interacts with the video thumbnail. The first degree of translucency can be higher in translucency than the second degree of translucency.

In another aspect of the user interface, the video thumbnail is borderless. The video thumbnail can be displayed at the periphery of the visible display area. In another aspect of the user interface, after a predetermined amount of time of user inactivity the video thumbnail is automatically rendered opaque.

In yet another aspect of the user interface, a universal resource locator can be dragged onto the video thumbnail to display video associated to the universal resource locator in the video thumbnail. Additionally, a file icon can be dragged onto the video thumbnail to display video associated to the file icon in the video thumbnail.

In one aspect, there is another method of presenting video on a display having a visible display area. A video input can be received for display from a video source. A video corresponding to the video input can be displayed in a viewing region of the display. The viewing region can be of a size that occupies a fractional portion of the visible display area. The video being displayed in a translucent fashion so that the video is visible and so that other content displayed on the computer display is visible through the video.

### DRAWINGS

The features and objects of alternate embodiments of the present disclosure will become more apparent with reference to the following description taken in conjunction with the accompanying drawings of various examples wherein like reference numerals denote like elements and in which:

FIGS. 1A-1B depict examples of embodiments of a system for presenting video according to one embodiment.

FIG. 2 depicts a component diagram of a user computing device according to one embodiment.

FIGS. 3A-3B depict exemplary software component modules for providing video according to one embodiment.

FIG. 4 depicts a flow diagram of a process for presenting video on a display according to one embodiment.

FIG. 5 depicts a flow diagram of a process for presenting video on a display according to one embodiment.

FIG. 6 depicts a screenshot of a user interface for showing translucent displayed video according to one embodiment.

FIG. 7 depicts a screenshot of a user interface showing non-translucent displayed video according to one embodiment.

FIG. 8A depicts a screenshot of a user interface showing a toolbar associated with the displayed video according to one embodiment.

FIG. 8B depicts a screenshot of a user interface showing text associated with the displayed video according to one embodiment.

FIG. 9 depicts a screenshot of a user interface showing an enlarged displayed video according to one embodiment.

FIG. 10A depicts a screenshot of a user interface showing a user interface menu according to one embodiment.

FIG. 10B depicts a screenshot of a user interface for selecting a video source according to one embodiment.

FIG. 10C depicts a screenshot of a user interface for selecting a video feed channel according to one embodiment.

FIG. 11 depicts a screenshot of a user interface showing an options menu according to one embodiment.

FIGS. 12A-12G depict examples of configurations of video thumbnail layouts on the screen of a display according to one embodiment.

FIG. 13 depicts an embodiment of a networked system for presenting video.

FIG. 14 depicts a component diagram of a media server according to one embodiment.

### DETAILED DESCRIPTION

A system and method of presenting video to a user is described herein. The system herein permits the display of one or more videos on a display. The one or more videos can be presented translucently. In addition, the one or more videos can be presented in small discrete video display regions on the periphery of a display screen so as to utilize a small percentage of screen space. Thus, the systems and methods described herein provide a multitasking environment wherein one or more videos are displayed visibly yet unobtrusively while a user interacts with other applications of a computing device. Once a user notices a video of interest, the user can further interact with the video to listen to audio or view the video in a selected format.

In one embodiment, the video display regions can be video thumbnails. As disclosed herein, a video thumbnail refers to a thumbnail-sized region of a display in which a video can be presented.

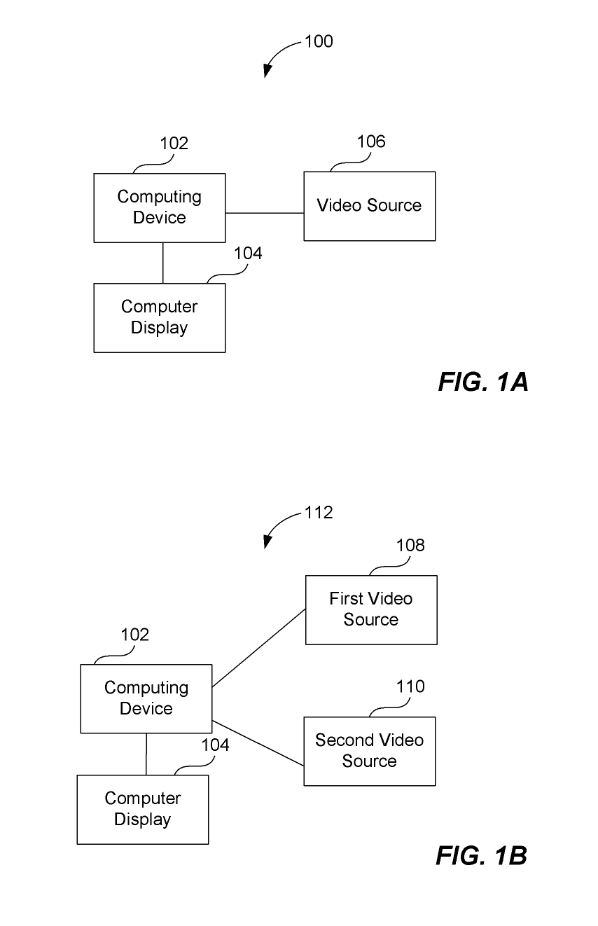

FIG. 1A depicts a system for presenting video. System 100 includes a computing device 102 that communicates with a video source 106 in order to receive a video signal from the video source 106. As used herein, video signals received by the computing device 102 can be either analog video or digital video. Upon receiving the video signal from the video source 106, the computing device 102 can then decode the video signal to a video output format that can be communicated to the display 104 for viewing.

In one embodiment, the video source can be a computer server that streams video to the computing device 102 over a computer network such as the Internet. In another embodiment, the video source can be a webcam that streams captured video through the Internet to the computing device 102. In yet another embodiment, the video source 106 can be another computing device that transmits video to the computing device 102 through a digital communication channel such as a USB port, an infrared port, a wireless port, or any other communication medium. In another embodiment, the video source 106 is a storage device. For example, the storage device can be an optical storage device such as compact discs, digital video discs, etc. In another example, the storage device can be magnetic storage devices such as a magnetic tape or a hard drive. In another embodiment, the storage device can be a solid-state memory device. Video source 106 can be any source or repository from which a video signal corresponding to moving images, in any form or format now known or to become known may be obtained for rendering into a visible perceptible form by a computer device.

For example, the video signal can correspond to a video clip. The video clip can be a prerecorded digital video file that is downloaded to the computing device 102. Playback controls such as rewind, pause, fast forward, etc. can be available for the video clip. In another example, the video signal can correspond to a playlist. The playlist can be a list of clips to be streamed one after the other to the computing device 102. Again, playback controls can be available for the video clips of the playlist. In yet another example, the video signal can correspond to a web channel. The web channel corresponds to an open channel that displays video coming from a specific source as the video becomes available. While no videos clips are available, the video signal can be absent, a single color or still image, while the channel is still open available for receipt of any video clip. Therefore, display of the video signal web channel would appear black or unmoving until a new video clip is fed through the web channel to the computing device 102. In one embodiment, the computing device can periodically poll the video source 106, for any new videos that have been recently added as part of the channel. Playback controls can also be available for the video clips of the web channel. In yet another example, the video signal can correspond to a live video stream. Because of the nature of the video stream, playback controls may be limited. For example, a fast forward control would be unavailable since the event associated with the received video is occurring live and simultaneously to the streaming of the video. If the live video stream is buffered, playback controls such as pause and rewind can be made available to the user.

Furthermore, the computing device 102 can be a laptop computer, a personal desktop computer, a game console, set-top box, a personal digital assistant, a smart phone, a portable device, or any other computing device that can be configured to receive video from a source for rendering into perceptible form on a display 104.

The computing device 102 can further be configured to receive live streaming of video from the video source 106, such as a UHF signal or a VHF signal or a cable television signal, or IPTV signal, or any other form of video broadcasting, such as live video web cast from an Internet site, etc. The computing device 102 can also be configured to receive pre-recorded or downloaded video from the video source 106. The computing device 102 can also be configured to receive a feed containing references to live video sources, such as RSS or MRSS feeds.

Likewise, the display 104 can be coupled to the computing device 102 in order to receive video signals and audio signals for presentation of a video. Examples of a display 104 can include a computer display, a flat panel display, a liquid crystal display, a plasma display, a video projector and screen, a CRT display or any other visual display that can be configured to display the video received from the computing device 102.

FIG. 1B depicts a system 112 for presenting video. In one embodiment, the computing device 102 can receive video signals from a plurality of video sources. For example, the computing device 102 can receive video signals from a first video source 108 and from a second video source 110. The video signals received from the first video source 108 and from the second video source 110 can then be communicated for visible display on the display 104. The first video source 108 and the second video source 110 can be any one of the video sources exemplified above in connection with video source 106. For example, the first video source 108 and the second video source 110 can be one or more media servers that stream video to the computing device 102, a UHF broadcasting transceiver, a VHF broadcasting transceiver, a digital broadcasting transceiver, etc. Other examples include a camcorder, a webcam, or any other device that can capture video and communicate the captured video to the computing device 102, for example as a “live” stream immediately after capturing the video, or as pre-recorded video.

In addition, the first video source 108 and the second video source 110 can be independent channels of communication that submit and transmit independent video signals to the computing device 102. In one example, the first video source 108 can be a television broadcasting transceiver that transmits broadcasting television signals to the computing device 102, while the second video source 110 can be a source of pre-recorded video, such as a tape or a DVD disc, a mass storage device that stores pre-recorded video, etc.

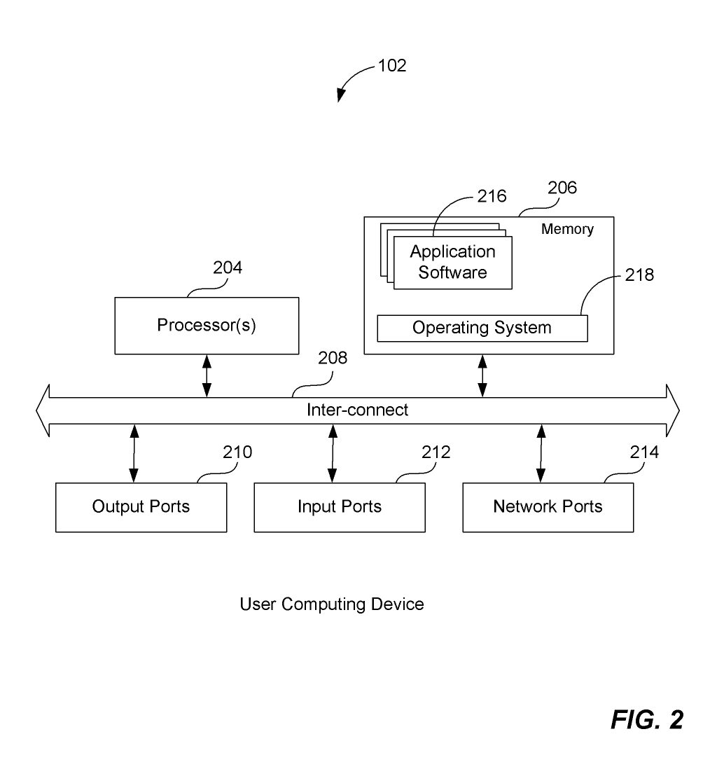

FIG. 2 depicts a component diagram of one example of a user computing device 102 according to one embodiment. The user computing device 102 can be utilized to implement one or more computing devices, computer processes, or software modules described herein. In one example, the user computing device 102 can be utilized to process calculations, execute instructions, receive and transmit digital signals, as required by the user computing device 102. In one example, the user computing device 102 can be utilized to process calculations, execute instructions, receive and transmit digital signals, as required by user interface logic, video rendering logic, decoding logic, or search engines as discussed below.

Computing device 102 can be any general or special purpose computer now known or to become known capable of performing the steps and/or performing the functions described herein, either in software, hardware, firmware, or a combination thereof.

The computing device 102 includes an inter-connect 208 (e.g., bus and system core logic), which interconnects a microprocessor(s) 204 and memory 206. The inter-connect 208 interconnects the microprocessor(s) 204 and the memory 206 together. Furthermore, the interconnect 208 interconnects the microprocessor 204 and the memory 206 to peripheral devices such input ports 212 and output ports 210. Input ports 212 and output ports 210 can communicate with I/O devices such as mice, keyboards, modems, network interfaces, printers, scanners, video cameras and other devices. In addition, the output port 210 can further communicate with the display 104.

Furthermore, the interconnect 208 may include one or more buses connected to one another through various bridges, controllers and/or adapters. In one embodiment, input ports 212 and output ports 210 can include a USB (Universal Serial Bus) adapter for controlling USB peripherals, and/or an IEEE-1394 bus adapter for controlling IEEE-1394 peripherals. The inter-connect 208 can also include a network connection 214.

The memory 206 may include ROM (Read Only Memory), and volatile RAM (Random Access Memory) and non-volatile memory, such as hard drive, flash memory, etc. Volatile RAM is typically implemented as dynamic RAM (DRAM), which requires power continually in order to refresh or maintain the data in the memory. Non-volatile memory is typically a magnetic hard drive, flash memory, a magnetic optical drive, or an optical drive (e.g., a DVD RAM), or other type of memory system which maintains data even after power is removed from the system. The non-volatile memory may also be a random access memory.

The memory 206 can be a local device coupled directly to the rest of the components in the data processing system. A non-volatile memory that is remote from the system, such as a network storage device coupled to the data processing system through a network interface such as a modem or Ethernet interface, can also be used. The instructions to control the arrangement of a file structure may be stored in memory 206 or obtained through input ports 212 and output ports 210.

In general, routines executed to implement one or more embodiments may be implemented as part of an operating system 218 or a specific application, component, program, object, module or sequence of instructions referred to as application software 216. The application software 216 typically can comprises one or more instruction sets that can be executed by the microprocessor 204 to perform operations necessary to execute elements involving the various aspects of the methods and systems as described herein. For example, the application software 216 can include video decoding, rendering and manipulation logic.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions may be embodied in digital and analog communication links for electrical, optical, acoustical or other forms of propagated signals, such as carrier waves, infrared signals, digital signals, etc.

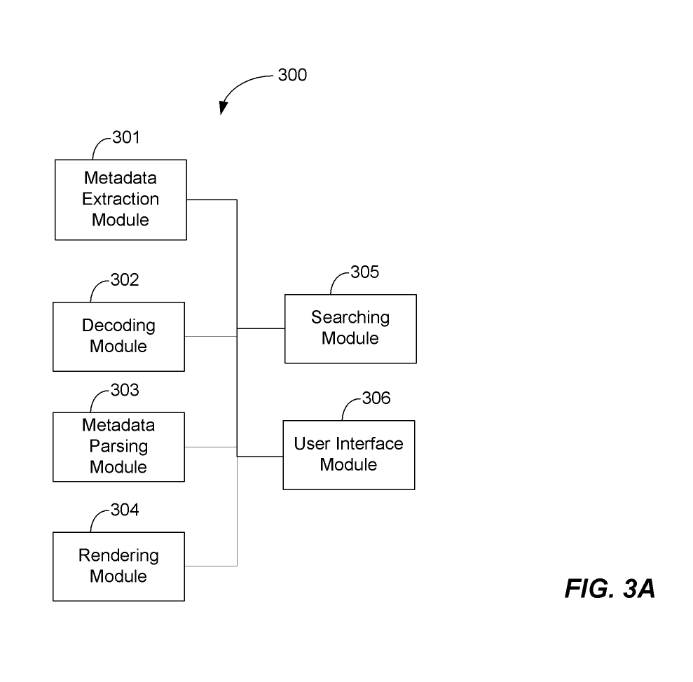

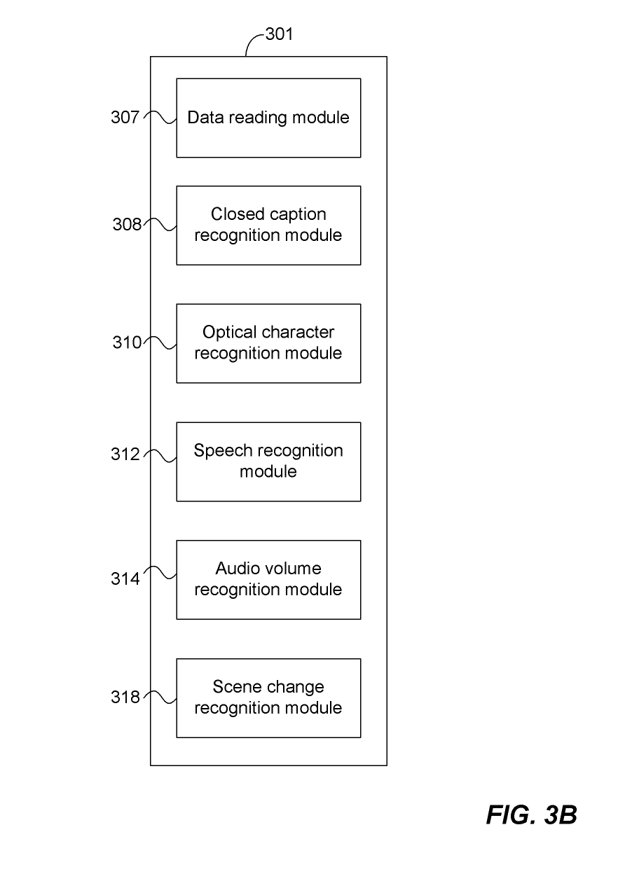

FIG. 3A depicts exemplary software component modules 300 for displaying video. The exemplary software component modules can include a metadata extraction module 301, a decoding module 302, a metadata parsing module 303, a rendering module 304, a searching module 305, and a user interface module 306. In one embodiment, the metadata extraction module 301, the decoding module 302, the metadata parsing module 303, the rendering module 304, the searching module 305, and the user interface module 306 can be separate components that reside in the user computing device 102 and permit display of video according to the methods and processes described herein. In another embodiment, the metadata extraction module 301, the decoding module 302, the metadata parsing module 303, the rendering module 304, the searching module 305, and the user interface module 306 can be combined as a single component and can be hardware, software, firmware or a combination thereof.

In one embodiment, the metadata extraction module 301 can be configured to extract metadata associated with the video signal. Metadata associated with the video signal received can include metadata embedded in the video signal, or associated header, data file, or feed information that is received in conjunction with the video signal. For example, associated metadata can include information related to the genre of the video, duration, title, credits, time tagging for indicating an event or other data, etc. As such, metadata associated with the video signal can comprise metadata that is included as part of the video signal, or as part of an associated header, data file, or feed. In addition, associated metadata can be extracted from the signal if the metadata is part of the video signal. Associated metadata can also include accompanying data such as data files, etc. that can be received in conjunction with the video signal. Once extracted, metadata can be read, parsed, and utilized to implement commands, business rules, thresholds, etc.

In one embodiment, the decoding module 302 can further be configured with logic to receive video signals, transcode the video signals into a format compatible with the display 104, and render the resulting frames for visual display.

In another embodiment, the metadata parsing module 303 can be utilized to read extracted metadata associated with the video, and execute commands or operations based on the content of the associated metadata. As such, the metadata parsing module 303 can be configured to receive business rules, and other criteria for determining whether based on metadata received an operation or command should be executed.

In a further embodiment, the rendering module 304 can be configured to receive multiple video signals from multiple video sources and multitask in order to simultaneously transmit the video signals of one or more video sources to the display 104. In addition, the rendering module 304 can also be configured with logic to operate video playback. For example, the rendering module 304 can be configured with a play operation, a stop operation, a fast forward operation, a pause operation and/or a rewind operation. Based on user input or another module's input, the rendering module 304 can execute any one of these operations when displaying video. In addition, the rendering module 304 can also be configured with logic to display a title of the displayed video.

In addition, the rendering module 304 can be configured to buffer video input received from the one or more video sources. The buffered video can correspond to live streams, or any other type of video that is streamed to the computing device 102. As part of the buffering operation, the video can be stored in a hard drive, cache, random access memory, or any other memory module coupled with the computing device 102.

In a further embodiment, the rendering module 304 can be configured with logic to render video with a degree of translucency. Various techniques known in the art can be utilized to render the displayed video to be translucent. In one example, the degree of translucency can be fifty percent. Thus, a displayed video and a display item (e.g., an icon, a window, a user's desktop, etc.) that are displayed in the same region of the display are both visible with the item being viewed “through” the translucent video. For example, if an icon is placed on a region of the screen in the display 104, and a window with a fifty-percent translucent displayed video is displayed so as to overlie on the icon in the same region in which the icon is being displayed, both the video and the icon can be visible. Moreover, because the translucency degree is fifty percent, the intensity of the displayed video image, and the intensity of the icon image are essentially the same. Therefore, the icon can be visible through the displayed video.

In another example, a degree of translucency of zero percent renders the displayed video with no translucency at all, and therefore the displayed video is opaque (i.e., non-translucent). Thus, when a displayed video and a display item (e.g., an icon, a window, etc.) are displayed in the same region, only the displayed video is visible. For example, if an icon is placed on a region of the screen in the display 104, and a window with the zero-percent translucent displayed video is overlaid on the icon on the same region in which the icon is being displayed, only the displayed video can be visible. Thus, the icon would be hidden behind the displayed video. Moreover, because the translucency degree is zero percent, the intensity of the displayed video image would be at its highest, and the icon would not be visible through the displayed video.

In one example, a one-hundred percent degree of translucency means that the video is transparent, such that the video cannot be seen at all. Thus, when a displayed video and a display item (e.g., an icon, a window, etc.) are displayed in the same region, the displayed video would not be visible at all.

In yet another embodiment, the rendering module 304 can be configured with logic to display the displayed video as a full screen display, as a video thumbnail, or as any other size required by a user. Furthermore, the rendering module 304 can also include audio control commands and operations that a user can utilize to control both the visual display and the accompanying audio portion, if any.

The user interface module 306 can be configured with graphical user interface items that are displayed at the display 104 in order to provide the user with tools for interacting with the display, rendering, searching, and/or manipulating of one or more video images being displayed at the display 104. As such, the user interface module 306 can include user input mechanisms to select the playing, stopping, seeking, rewinding, pausing or fast forwarding video. In addition, the user interface module 306 can also include commands for maximizing a displayed video, minimizing a displayed video, displaying a video clip as a video thumbnail, receiving user input for setting a translucency percentage, relocating the location of one or more video thumbnails or displayed videos on the display 104, etc. The user interface module 306 can further include logic to interpret cursor control or user input commands from a user (via for example a mouse, keyboard, stylus, trackball, touchscreen, remote control, or other pointing device) such as selecting or clicking on a video thumbnail or a displayed video, double-clicking on a video thumbnail or a displayed video, permitting a user to hover over or roll-over a video thumbnail, etc. User input mechanisms provided by the user input interface module 306 can include drop down menus, pop up menus, buttons, radio buttons, checkboxes, hyperlinked items, etc.

The user interface module 306 can be further configured with logic to operate video playback and display. For example, utilizing a mouse, or other pointing device, a user can click on a video display region, such as a video thumbnail, in order to turn on or turn off the audio associated with the displayed video. In another example, a user can utilize a mouse pointer to hover over the area of a video display region in order to change the degree of translucency of the displayed video to opaque (i.e. zero percent translucent). In yet another example, a user can utilize a mouse pointer to double click on a video display region in order to change the size of the video display region. For example, if the video display region is a video thumbnail that occupies a small amount of space of the display 104, rolling over or double clicking on the video thumbnail can increase the size of the video display region to occupy a larger portion of the screen of the display 104.

Furthermore, the user interface module 306 can also permit a user to rewind and view a portion of the video. The video can be buffered and saved in a memory module in order to permit later viewing of the video, pausing and resuming the viewing of the video, etc.

The user interface module 306 can also be configured with logic to permit a user to select the video source or video sources from which to receive video signals for display. In addition, the user interface module 306 can also be configured to provide user interface menus for setting display and audio preferences, etc.

The user interface module 306 can be configured to permit a user to select the position of the presented video in the display area. In one example, the user interface module 306 can include logic to allow a user to drag video thumbnails or video windows or video display regions to any position on the screen as selected by the user. In another example, the user interface module 306 can include logic to allow a user to set the layout, placement and number of video display regions as positioned on the display 104. In another example, the user interface module 306 can include logic to allow a user to select a corner layout, a vertical stack layout, a horizontal stack layout, a random layout, a stacked layout, or any other layout configuration selected by the user. In addition, the user interface module 306 can be configured to permit the user to place a group of thumbnails in one of the corners of the screen, or on the midsections of the border of the screen, etc.

The searching module 305 can also be included as a separate component of the computing device 102 in order to permit a user to enter queries and search for videos that the user may be interested in. For example, if the video source 106 is a database or a computer server that accesses such database, the searching module 305 can be configured to receive user queries and retrieve videos from the database or request a server to retrieve videos from a database or other sources. In one embodiment, the searching module 305 may contain logic or intelligence whereby multiple video sources accessible over a network, for example, the Internet, can be searched for videos matching user search criteria. In another embodiment, videos can be streamed automatically to the computing device 102 according to predefined keywords, or video requests provided by the user.

In one embodiment, the rendering module 304 resides as a separate application from the searching module 305 and the user interface module 306. Likewise, the user interface module 306 can reside as a separate application. In addition, the searching module 305 can also reside as a separate application. In yet another embodiment, the rendering module 304, the searching module 305 and the user interface module 306 can interact together as computer processes as a single application residing at the computing device and being executed on the processor 204 of the computing device. Additionally, the searching module 305 may reside in whole or in part on a server operated by a service provider.

FIG. 3B depicts exemplary software component modules for providing video according to one embodiment. The metadata extraction module 301 can be configured to include recognition modules that extract data from the video signal and utilize the extracted data to execute operations. In addition, metadata extraction module 301 can further be configured to read accompanying data received with the video signal, such as a header, data file, feed, etc.

In one example, the data or metadata extracted from the video or feed can be compared with strings or terms or events or keywords representing user preferences. Thus, commands, such as enlarging, outlining or flashing the video display or changing the volume, or changing translucency or position, may be executed when relevant metadata is found in the displayed video.

In one embodiment, the metadata extraction module 301 can include a data reading module 307 which is configured with logic to read metadata that is received in conjunction with a video.

In one embodiment, the metadata extraction module 301 can include a closed caption recognition module 308 which is configured with logic to extract closed caption data associated with a video. The closed caption recognition module 308 can further be configured to match closed caption data with one or more search strings or words or text. For example, if a user is interested in the stock market, the text string “stock market” can be utilized as a search string. If the closed caption recognition module 308 matches the string “stock market” with extracted closed caption data, the closed caption recognition module 308 can execute a command or operation, or otherwise send a message such that another logic module executes a command or predetermined operation. In one example, closed caption recognition module 308 can send a message to the rendering module 304 indicating that the closed caption text is relevant to the user. Upon receiving such message, or any other similar indication, the rendering module 304 can enlarge the displayed video and place the displayed video on the center of the display region of display 104.

In another embodiment, the metadata extraction module 301 can include an optical character recognition module 310 which is configured with logic to recognize characters displayed as part of the displayed video. Thus, if a user interested in the stock market is viewing the displayed video on a video thumbnail, and the text “stock market” is displayed as part of the displayed video, the optical character recognition module 310 can recognize the characters of the string “stock market” in the displayed video and execute a command or operation, or otherwise send a message such that another logic module executes a command or predetermined operation. For example, the optical character recognition module 310 can send a message to the rendering module 304 which can then enlarge the video display region. In another example, upon receiving the message from the character recognition module 310, the rendering module 304 can display the text in a separate window of the display.

In another embodiment, the metadata extraction module 301 can include a speech recognition module 312 configured with logic to recognize speech associated with the displayed video. Similar to the examples provided above, if a user interested in the stock market is viewing the displayed video on a video thumbnail, and the words “stock market” are spoken as part of the audio associated with the displayed video, the speech recognition module 312 can recognize the spoken words “stock market” and execute a predetermined operation. In one example, the operation includes sending a message to the rendering module 304, which upon receiving the message enlarges the video display region. In another example, the operation includes sending a message to the rendering module 304 to increase the audio volume associated with the displayed video.

In another embodiment, the metadata extraction module 301 can include an audio volume recognition module 314 configured with logic to recognize volume of the audio associated with the displayed video. For example, a user can set a threshold volume, or level of decibels, such that when the audio associated with the displayed video reaches a volume that is greater than such threshold level, such as crowd cheers during a sports event, the audio volume recognition module 314 triggers an operation to be executed. The operation executed can be a request to the rendering module 304 to enlarge the video thumbnail, change translucency of the video thumbnail, move the video thumbnail to a different place on the display, etc.

In yet another embodiment, the metadata extraction module 301 can include a scene change module 318 configured with logic to recognize changes in frames associated with the displayed video. For example, a user can outline an area of the screen, such that when the corresponding area of a frame changes, such as a sports scoreboard highlight, the scene change module 318 triggers an operation to be executed. The operation executed can be a request to the rendering module 304 to enlarge the video thumbnail, change translucency of the video thumbnail, move the video thumbnail to a different place on the display, etc.

The change in frame can be implemented for example, to recognize that a new video clip is now available at a video channel. Based on the change of frames, one or more operations can be executed as discussed above.

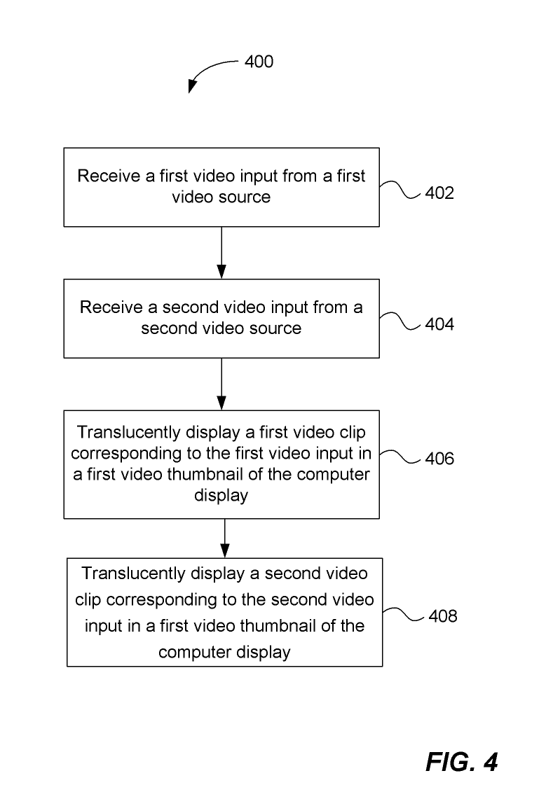

FIG. 4 depicts a flow diagram of a process for presenting video on a computer display 104. At process block 402, a first video input is received from a first video source 108. Process 400 continues to process block 404.

At process block 404, a second video input from a second video source 110 is received at the computing device 104. As previously mentioned, the first and second video sources can be any one of a streaming server, a webcam, a camcorder, a storage device, a broadcast signal, a webcast signal, or any other source of video signals. The process 400 continues at process block 406.

At process block 406, a first video clip corresponding to the first video input is played in a first video thumbnail on a computer display 104. The first video clip can be displayed translucently according to user preferences that have been set for a degree of translucency of the first video clip. Process 400 continues to process block 408.

At process block 408, a second video clip corresponding to the second input can be translucently displayed in a second video thumbnail on a computer display 104. Again, the first video thumbnail and the second video thumbnail can be displayed on the display translucently and such that a user working on other applications can view the first video thumbnail and the second video thumbnail while still utilizing the other applications. The user can further select the video of one of the two video thumbnails if the user notices an item of interest being played at either the first video thumbnail or the second video thumbnail.

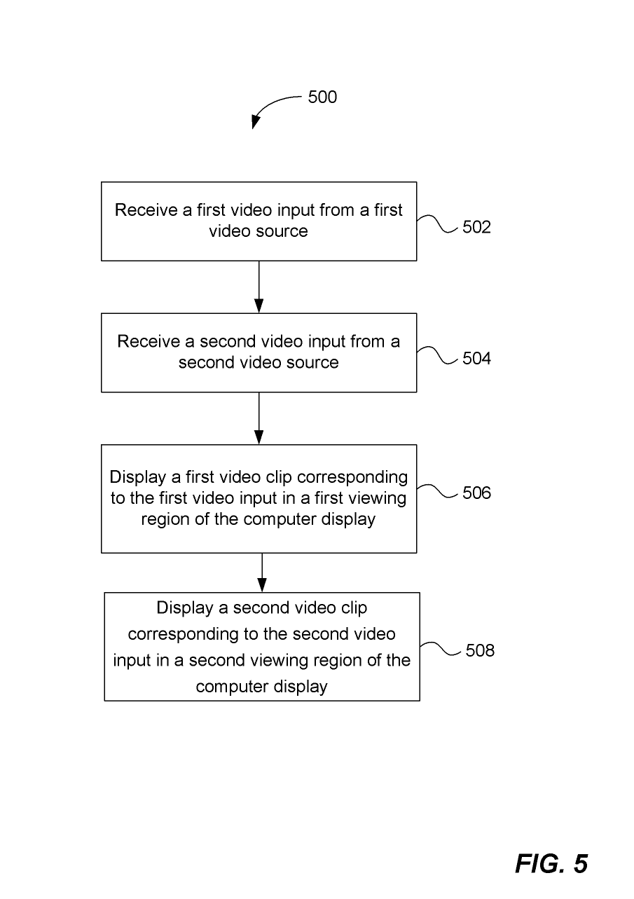

FIG. 5 depicts a flow diagram of a process for presenting video on a computer display 104. At process block 502, the first video input is received from a first video source 108. The first video input can include video signals corresponding to a video clip to be displayed on a computer display 104. Process 500 continues to process block 504.

At process block 504, a second video input is received from a second video source 110. As previously mentioned, multiple video sources can be received at the computing device 102 and simultaneously displayed on the computer display 104. Process 500 continues at process block 506.

At process block 506, the video clip corresponding to the first video input is displayed in a first viewing region of a computer display 104. The first viewing region is preferably a relatively small, borderless display area on the screen of the computer display 104. Process 500 continues to process block 508.

At process block 508, a second video clip corresponding to the second video input is displayed in a second viewing region of the computer display 104 similar in size and shape to the first viewing region. The second viewing region, also preferably a relatively small, borderless display area on the screen of a computer display 104, can be configured so that the first video clip and the second video clip are simultaneously or sequentially displayed on the computer screen and visible to a user who views the display.

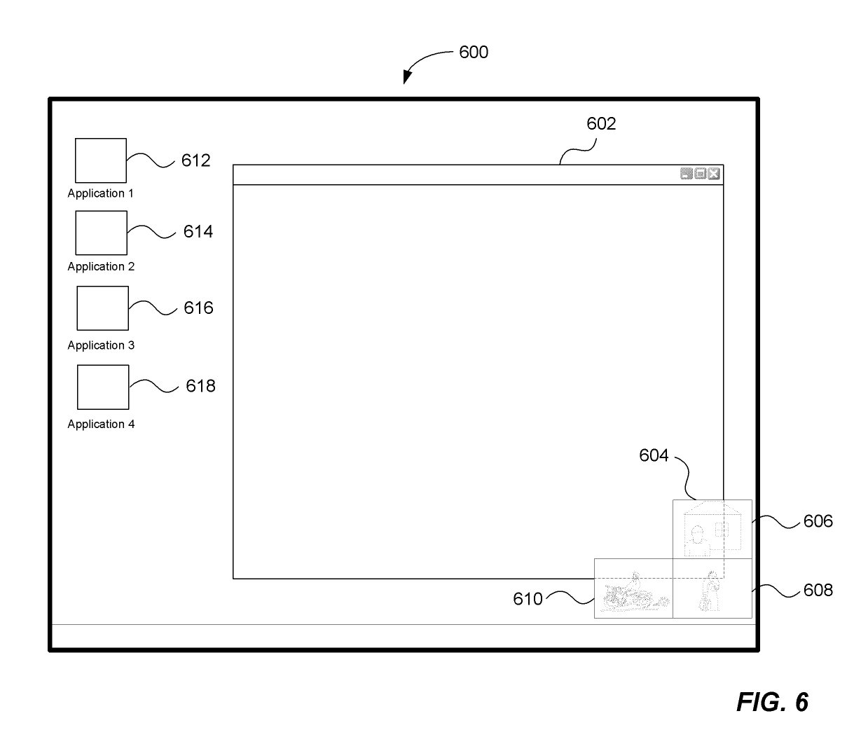

FIG. 6 depicts a screenshot of a user interface for presenting video. The user interface 600 can include at least one or more video thumbnails that are displayed in a pre-specified position on the screen of the display 104. For example, video thumbnail 606 and video thumbnail 608 and video thumbnail 610 can be positioned at the bottom right hand corner of the screen of the display 104.

As previously disclosed, a video thumbnail refers to a fractional region of a display in which a video can be presented. In one example, the size of the video thumbnail can be set by a user. In another example, the size of the video thumbnail can be a predetermined fixed area (e.g., 64×48 pixels), etc.

Furthermore, in one example, a video thumbnail can present the output display of a media player. The video thumbnail can be sized similar to an image thumbnail as it is known in the art. In contrast to an image thumbnail, a video thumbnail includes playback of a video, such as a pre-recorded video clip, a live video stream or broadcast, etc. Therefore, video thumbnail 606, video thumbnail 608 and video thumbnail 610 can each include playback of a video.

In addition, the video playback of video thumbnail 606 can be different from the video playback of video thumbnail 608, which in turn can also be different from the video playback of video thumbnail 610. As previously discussed, each of the video thumbnails can correspond to a different video source. For example, video thumbnail 606 can correspond to a television broadcast channel, video thumbnail 608 can include video playback of a streaming video that is received from an Internet server, and video thumbnail 610 can include video playback of a live transmission of a webcam over a computer network. In other examples, video thumbnails can be used to display new programs, financial tickers, security cameras such as “nanny cams,” or any other videos that a user might desire to monitor while performing other tasks on the user's computer device.

Each of the video thumbnails presented as part of user interface 600 can be displayed translucently, depending upon the degree of translucency selected by the user. As previously mentioned, the user can set the translucency degree to be in a range of zero percent to a one hundred percent. In one embodiment, a default translucency of fifty percent can be established in order to permit the video thumbnails to be visible and yet allow other user interface images to also be visible through the video thumbnails. As such, a user interaction window 602 can correspond to a graphical user interface of an application, such as email or word processing, being executed at the computing device 102. The user interaction window 602 can include a frame 604 that is visible through video thumbnail 606, video thumbnail 608 and video thumbnail 610 if video thumbnails 606, 608 and 610 are presented as translucent. For example, the bottom right hand corner 604 of the user interaction window 602 can be made visible through thumbnails 606, 608 and 610.

In one embodiment, the video thumbnails are configured to allow interaction with images or other user interfaces that are visible through the video thumbnails by pressing a key or providing another indication. In one example, a default or user-defined interfacing sequence (e.g., “ALT” key and pointer click, double selection of the “ALT” key, middle button of a pointing device such as a mouse) can be configured to toggle the video thumbnails and the user interfaces that are visible through the video thumbnails, or dismiss the video thumbnails for a predetermined period of time.

In another example, while the bottom right hand corner of the user interaction window 602 can be seen through the video thumbnail 608, any mouse interaction of the user on the region occupied by the video thumbnail 608 would be interpreted as an interaction with the video thumbnail 608. If for example the user wants to grab the corner of the video thumbnail 608, the user can press on the “ALT” key of the keyboard, or any other designated key, such that upon pressing the designated key, the mouse actions can be interpreted to pertain to the corner of the user interaction window 602.

When a user interacts with the application corresponding to window 602, user interaction window 602 can remain active and visible while the video playback of video thumbnails 606, 608 and 610 are simultaneously playing video. Thus, a user can view the video displayed on each of the video thumbnails 606, 608 and 610 while working with the computer application corresponding to user interaction window 602. For example, if user interaction window 602 corresponds to a word processor, a user can type a document on the word processor related to user interaction window 602 while having video being displayed on video thumbnails 606, 608 and 610. The video displayed in each of these thumbnails can be displayed with a translucency degree set by the user. In this manner, the video displayed in the video thumbnails 606, 608 and 610 can be less intrusive on the interaction of the user with the word processor corresponding to user interaction window 602. The translucent displayed video presented on video thumbnails 606, 608 and 610 permits the user to multitask, and lets one or more displayed videos to play until the user sees a scene, episode, caption or other item of interest. While the user interacts with other user interface images, such as computer icons, the video playback of video thumbnails 606, 608 and 610 can continue to be displayed. For example, computer icons 612, 614, 616 and 618 can be located on the computer screen of the display 104 and upon a user interacting with any of these icons, the video playback of video thumbnails 606, 608 and 610 can continue playing simultaneously.

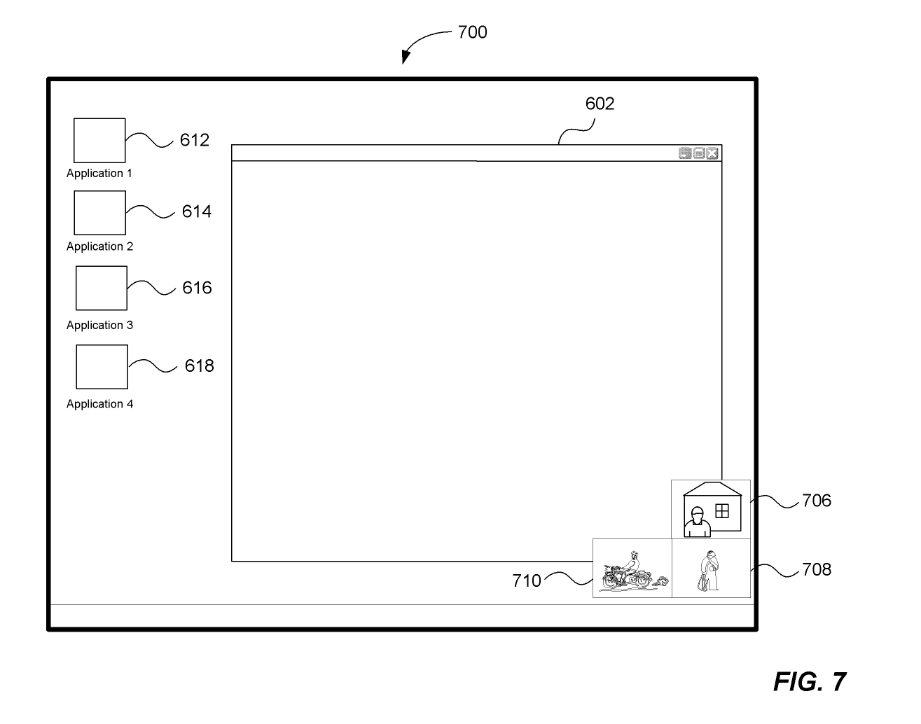

FIG. 7 depicts a screenshot of a user interface 700 showing opaque (i.e., non-translucent) video display regions. In one embodiment, the video thumbnails can further be configured to automatically become opaque (e.g., non-translucent), when the user has been inactive for a predetermined period of time. For example, an idle time can be counted for a corresponding period of time in which the user does not provide any input, for example through keyboard typing, a point-and-click device, etc., to the computing device. If the idle time reaches a predetermined threshold (e.g. 30 seconds), the video thumbnails can be displayed opaquely. Upon the user providing an input, the video thumbnails can be displayed translucently again.

In another embodiment, upon a user noticing a video clip that the user is interested in, the user can utilize a mouse pointer or other pointing device to hover over one of the video thumbnails 706, 708, or 710. The video rendering module 304 can be configured with logic to display video thumbnail 706 as an opaque displayed video. In other words, video thumbnail 706 can be displayed with zero degree of translucency. The rendering module 304 can be configured to interact with the user interface module 306 to receive a mouse input that indicates a cursor hovering over the video thumbnail 706. Upon receiving a signal from the user interface module, the rendering module can switch the degree of translucency of the video thumbnail 706 to be zero. In other words, no image or graphic can be seen through the video playback of the video thumbnail 706. For example, user interaction window 602 cannot be visible underneath video thumbnail 706. As shown in FIG. 7, the bottom right hand corner of the frame of the user interaction window 702 is blocked and cannot be seen through video thumbnail 706.

In one embodiment, video thumbnail 706 can be changed to be opaque, i.e. not translucent, upon a user clicking once on the video thumbnail 706. In another embodiment, the video thumbnail 706 can be changed to be opaque upon a user double clicking on the video thumbnail 706. In yet another embodiment, the video thumbnail 706 can become opaque upon a user entering any other predetermined user interface command.

Upon the selection of a video thumbnail such as video thumbnail 706, the adjacent video thumbnails, or any other video thumbnails playing video, such as video thumbnail 710 and video thumbnail 708, can continue to translucently play video. As such, only the video thumbnail that the user selects is shown as opaque, while the remaining video thumbnails can still be presented as translucent. In another embodiment, upon selecting any video thumbnail, such as video thumbnail 706, the rest of the adjacent video thumbnails simultaneously playing video, are also shown as opaque such that no image or graphical user interface is visible through the display of the video in the video thumbnails. Alternatively, the non-selected video thumbnail can “pause” or “freeze” until selected or until the playing thumbnail is deselected.

Furthermore, the user can also utilize hovering over or clicking mouse pointer mechanisms in order to control the audio of each one of the video playback and the video thumbnail 706, 708 and 710. In one example, a user can click on a video thumbnail to toggle the audio from inactive to active. In another example, a user can click on different video thumbnails to deactivate the audio on one video thumbnail while at the same time activating the audio on another video thumbnail. In another embodiment, the audio of a displayed video of a video thumbnail can be turned on upon a mouse pointer hovering over the video thumbnail. Thus, in one example, a user can be working on a word processor related to window 602 and thereafter, upon the user hovering over video thumbnail 706, the audio or sound corresponding to the video playback in video thumbnail 706 can be activated. Of course, other user interface mechanisms for controlling video and/or audio are contemplated, such as menus, dialog boxes, sidebars, buttons, etc.

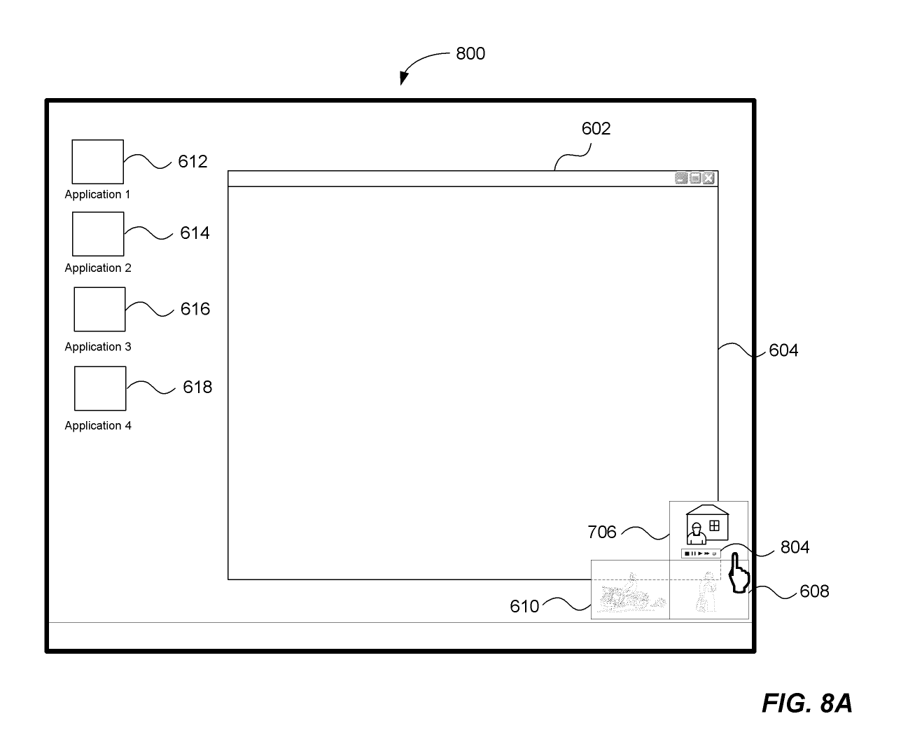

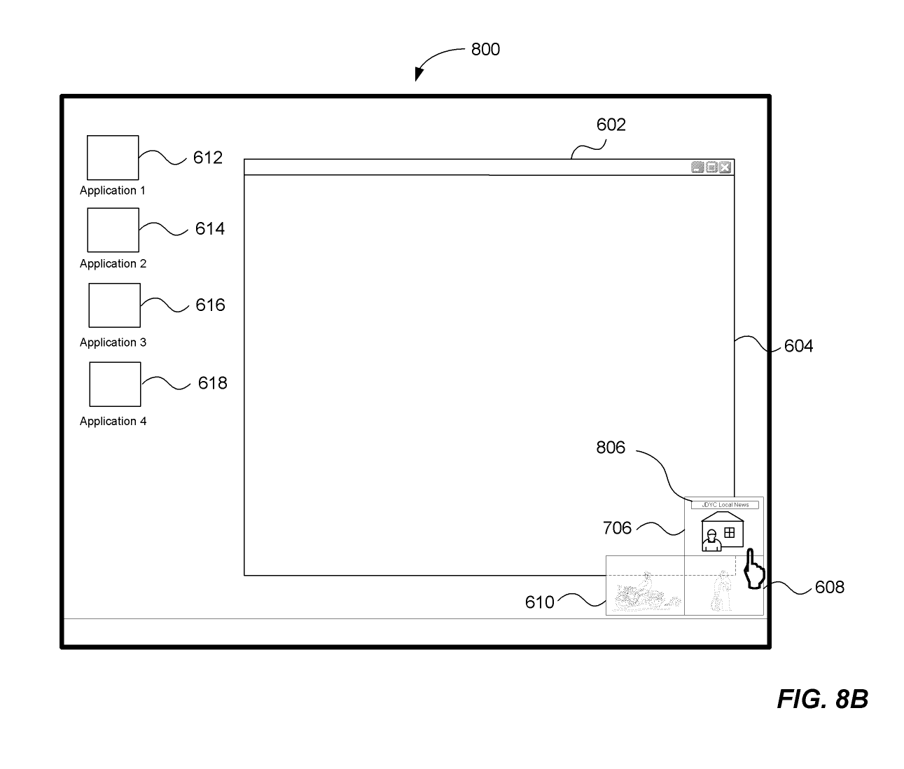

FIG. 8A depicts a screenshot of a user interface 800 showing a toolbar 804 associated with the displayed video according to one embodiment. The toolbar 804 can include buttons for playback control such as play, pause, stop, rewind, fast forward, etc. In addition, the toolbar 804 can also include a button for enlarging the size of the video display region from a thumbnail size to a larger-size window. For example, the video thumbnail 706 can be enlarged to occupy the entire area of the display 104. In another example, the enlarge button can be configured to enlarge the video display region to occupy a larger fraction of the area of the screen of the display 104. In an alternative embodiment, the pre-selected fraction (or percentage) of the area of the screen can vary as a function of the resolution of the video being viewed, such that a lower resolution video would not be enlarged to a degree that visibly degrades the perceptibility of the video. In one embodiment, the video thumbnail 706 can be displayed with a toolbar 804 upon a user selecting the video thumbnail 706. In another embodiment, the toolbar 804 can be displayed by default in every video thumbnail or in another portion of the display area.

FIG. 8B depicts a screenshot of a user interface 800 showing text 806 associated with the displayed video according to one embodiment. In one example, the text 806 can be the title of the clip or channel being displayed. In another example, the text 806 can include the length of the video and elapsed time. In another example, the text 806 can include closed caption text. In yet another example, advertisement text can be displayed. In one embodiment, the video thumbnail 706 can be displayed with text 806 upon a user selecting the video thumbnail 706. In another embodiment, the text 806 can be displayed by default in every video thumbnail or in another portion of the display area.

The user can select the video thumbnail 706 in multiple ways. In one example, the user can select the video thumbnail 706 by hovering over with a mouse pointer over the video thumbnail 706. In another embodiment, a user can select the video thumbnail 706 by clicking once on the video thumbnail 706. In yet another embodiment, the user can select video thumbnail 706 by double clicking on the video thumbnail 706 utilizing a mouse pointer.

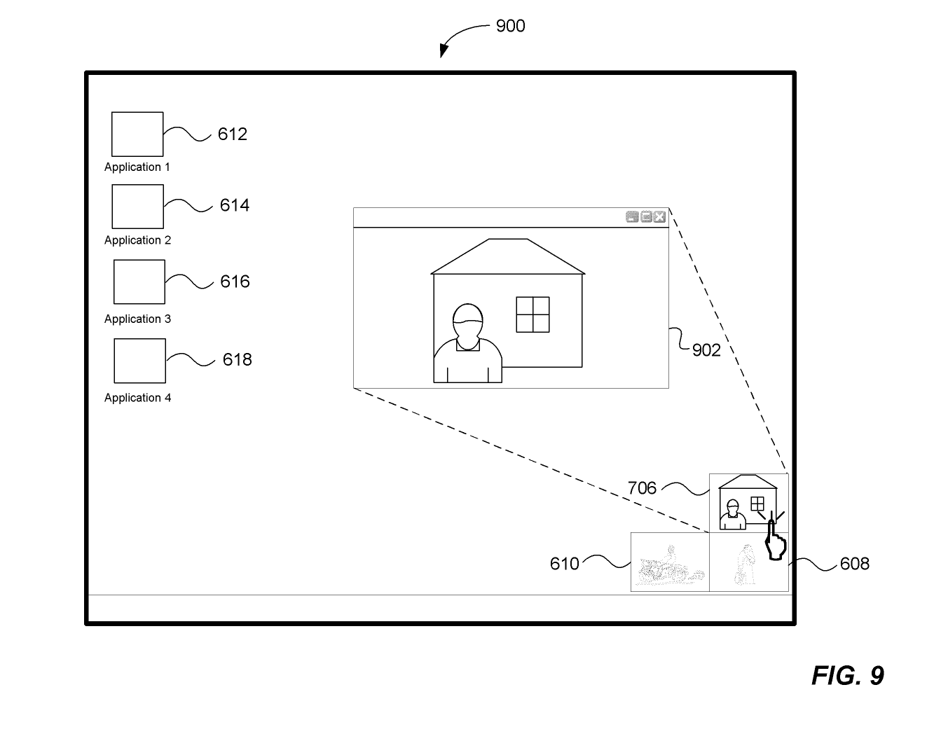

FIG. 9 depicts a screenshot of a user interface 900 showing an enlarged displayed video. In one embodiment, the enlarged video can be presented to the user upon the user double-clicking on one of the video thumbnails 606, 608, or 610. In an alternative embodiment, this can result from a user clicking, hovering over, or otherwise selecting the video thumbnail 706, or a button in the toolbar 804 or text area 806. The display 902 can consist of another window that displays the video displayed in video thumbnail 706 in an enlarged version. When the video is enlarged on video window 902, the video can be displayed at a higher quality. In one example, the video displayed on the video thumbnail 706 can be displayed at a lower pixel resolution than when enlarged. In another example, the video thumbnail 706 can be displayed at a lower frame rate than when enlarged.

Window 902 can further be displayed associated with other control user interfaces such as buttons for volume control, play, pause and stop, or any other video and/or audio manipulation buttons or user interfaces. An additional user interface that can be presented with video window 902 can be a user interface mechanism for minimizing the video window 902 into a video thumbnail, such as video thumbnail 706, or any resized video display region, including full-screen mode.

In another embodiment, the displayed video can be enlarged and displayed in the window 902 by the rendering module 304 upon receiving a command from one or more of the data reading module 307, closed caption recognition module 308, the optical character recognition module 310, the speech recognition module 312, audio volume recognition module 314, and the scene change recognition module 318, as discussed above.

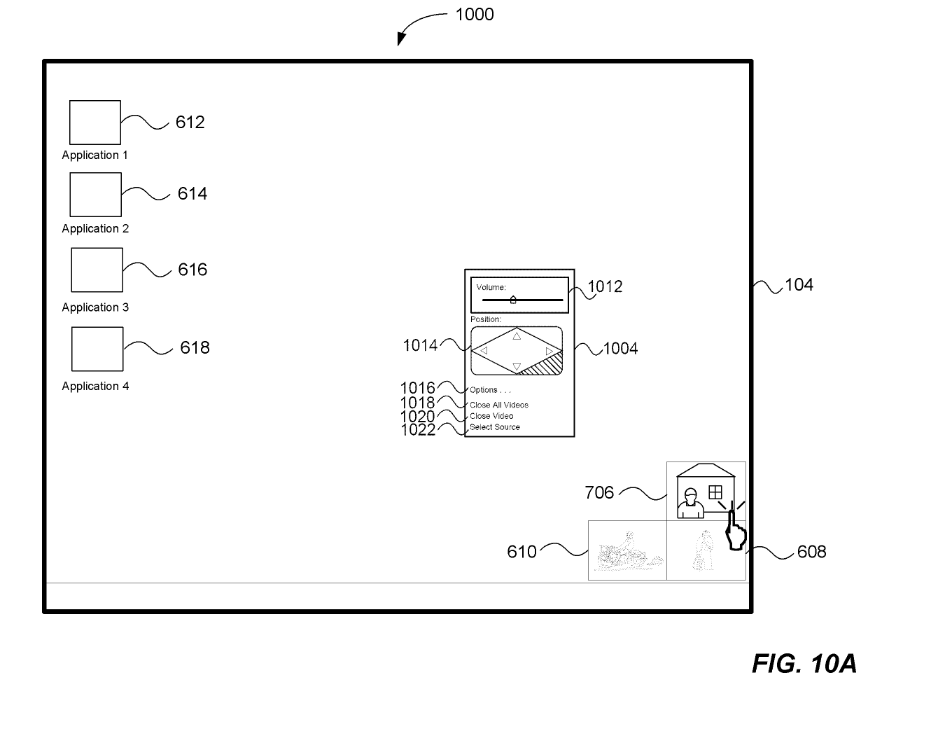

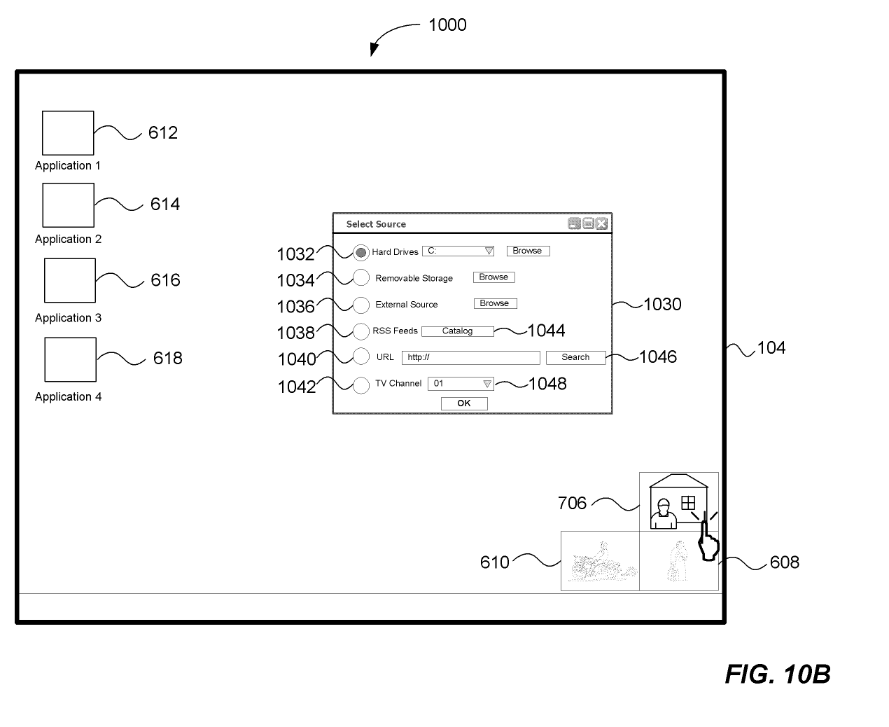

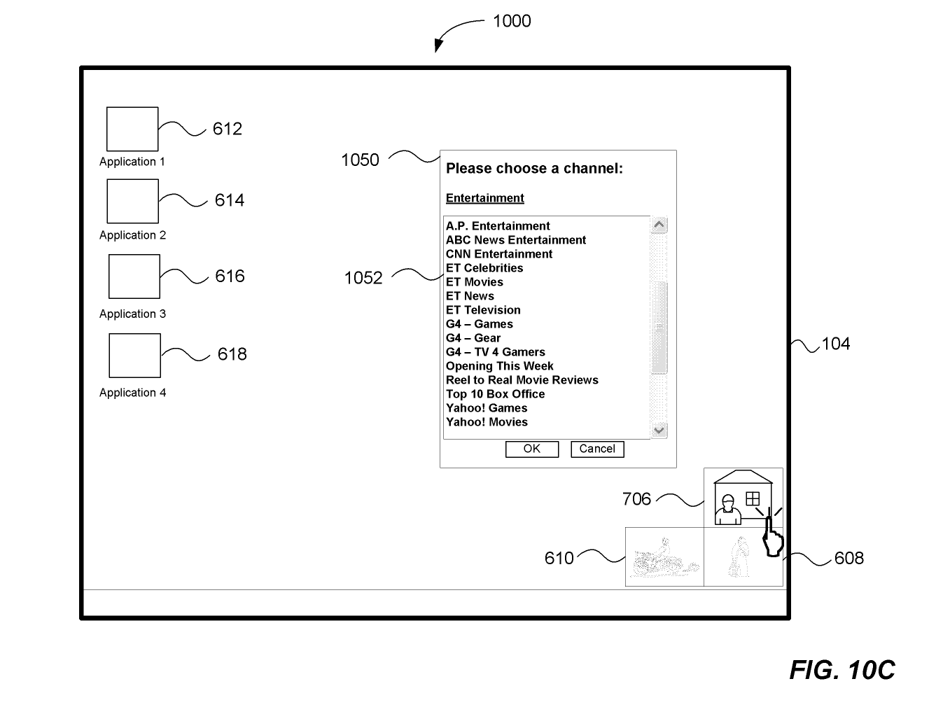

FIG. 10A depicts a screenshot of a user interface 1000 showing a user interface menu 1004. A user can select a menu to be displayed for each of the video thumbnails 706, 610 and 608, by double-clicking, right clicking, or otherwise selecting the desired video thumbnail. For example, the menu 1004 is displayed upon a user selecting the video thumbnail 706. A user may invoke a menu by utilizing a mouse pointer and right clicking on one of the video thumbnails 706, 610 or 608. In another embodiment, the user can be provided with an option to double-click on a video thumbnail for a menu to be displayed. A menu 1004 can be displayed upon a user selecting a pre-specified operation to cause the display of menu 1004. Menu 1004 can include a slide bar 1012 or another user interface mechanism that can allow the user to set the volume of the audio corresponding to the displayed video in the video thumbnail 706, for example, or the resolution, frame rate, translucency, default size, position, or number of video thumbnails displayed.

In another embodiment, a selector/indicator 1014 can also be included as part of menu 1004. The selector/indicator 1014 can permit a user to configure the position where the video thumbnails are to be displayed by utilizing a point and click input control such as a mouse, a touchpad, etc. In one example, the position of the video thumbnails can be on the upper right hand corner. In another example, the position of the video thumbnails can be on the upper left hand corner. In yet another example, the position can be on the bottom left hand corner. Alternatively, in another example, the position can be in the bottom right hand corner of user interface 1000. In another example, the video thumbnails may be positioned equidistant of each other across the top of user interface 1000. In another example, the video thumbnails may be positioned across the bottom of user interface 1000. In yet another example, the position of the video thumbnails may be positioned along the left side or the right side of user interface 1000. In yet another example, the video thumbnails can be positioned randomly on user interface 1000. As such, the positioning of the video thumbnails can be user-defined, system-defined, or a combination thereof.

In another example, the selector/indicator 1014 can permit a user to position a corner layout, a vertical stack layout, a horizontal stack layout, a random layout, a stacked layout, or any other layout configuration selected by the user. In addition, the selector/indicator 1014 can be configured to permit the user to place a group of thumbnails in one of the corners of the screen, or on the midsections of the border of the screen, etc.

Once the user selects a corner or side for display of the video thumbnails, the position of the video thumbnails can also be reflected on the position selector/indicator 1014. For example, the position selector/indicator 1014 can show a representative image of the screen, with the selected corner highlighted with a specific color, or with an image of the thumbnails relative to the display area.

In one embodiment, upon receiving a selection of the corner of display from the user, the video thumbnail associated with the display of the menu 1004 can be placed at the selected corner. In another embodiment, upon the user selecting the position with the position selector/indicator 1014, all of the video thumbnails are moved from one corner to the selected corner of the screen, or other selected position.

In another embodiment, the user can reposition the video thumbnails by dragging and dropping one or more video thumbnails in an area of the display. In another embodiment, the user can reposition a set of video thumbnails to an area of the screen via a “flick” i.e., clicking and moving the point-and-click device (e.g. mouse) with sufficient speed in the direction of the area of the screen where the set of video thumbnails are to be repositioned.

With reference once again to FIG. 10A, an options menu item 1016 can also be provided to allow a user to further define preferences and configurations regarding the display of the video clip, etc. Another example of a menu item that can be included in menu 1004 can be a close all videos item 1018 that provides the user the option to close all of the video thumbnails playing video on the screen of the display 104. Yet another example of a menu item that can be provided at the menu 1004 can be a close video item 1020 that will permit a user to close the current video item selected to display the menu 1004. Yet another item that can be provided as part of menu 1004 can be a select source item 1022. The select source item 1022 can be utilized by a user to select the video source of the video being displayed at the selected video thumbnail 706.

FIG. 10B depicts a screenshot of a user interface 1000 showing a user interface window 1030 for selecting a video source. Once a user chooses the select source item 1022, a selection window 1030 can be provided as a user interface to permit a user to select the video source for the selected thumbnail. As such, a user can select the video source for each of the thumbnails 706, 608, and 610 by opening the menu 1004 for the particular video thumbnail, and selecting the select source menu item 1022.

A user can select a video source such as a streaming server or a web camera or a camcorder connected to the computing device, or any other media source available. In one example, a menu option 1032 permits a user to select a video file from a hard drive or mass storage device. The file in the hard drive can be found utilizing standard known methods for file searching. The hard drive can be a local hard drive or a network hard drive. In another example, a menu option 1034 permits a user to browse for video files in a removable storage device, such as a memory stick, a memory card, DVD, etc. In another example, a menu option 1036 can permit a user to select an external video source that is connected to the computing device 102, for example, a camera input can originate from a digital video camera, an analog video camera, etc. In yet another example, a menu option 1038 can permit a user to select a feed, such as a Really Simple Syndication (RSS) feed. Thus, when the user selects button 1044, an RSS catalog box can be provided to the user to allow the user to select an RSS feed. In alternate embodiments, other user interface configurations can be utilized to access RSS feeds.

In another example, a menu option 1040 can be utilized to permit a user to enter a Universal Resource Locator (URL) that references a computer network address of a video. For instance, the URL can reference a digital video file that resides on a streaming server. Alternatively, the URL can reference a network address of a web cast. Thus, in general, a user can enter a network address in formats and/or protocols now known or to become known that references a digital video source. In one embodiment, a search button 1046 can be provided to a user to search for videos on a network, including intranets and the Internet.

In another example, a menu option 1042 can permit user to select a television broadcast or cable channel. A television tuner can be utilized as an input to the computing device 102. In one embodiment, a drop down list 1048 can be provided to a user to select a television channel as the video source.

In another embodiment, the user can select a video source by dragging and dropping a user interface object onto a video thumbnail. For example, the user can drag and drop a universal resource locator link onto a video thumbnail. The universal resource locator can be parsed to identify the network location of the video source. The video can then be requested from the video source corresponding to the universal resource locator, and displayed in the video thumbnail. In another example, the user can drag and drop an icon corresponding to a video file onto a video thumbnail. Of course, the user can choose a video source via other mechanisms now known or to become known.

FIG. 10C depicts a screenshot of a user interface for selecting a video feed channel according to one embodiment. For example, once the user selects button 1044, a catalog box 1050 can be displayed to permit the user to select the video feed channel. One or more channels can be available to the user as part of a channel list 1052. The channels listed in the channel list 1052 can be user-defined or system-defined.

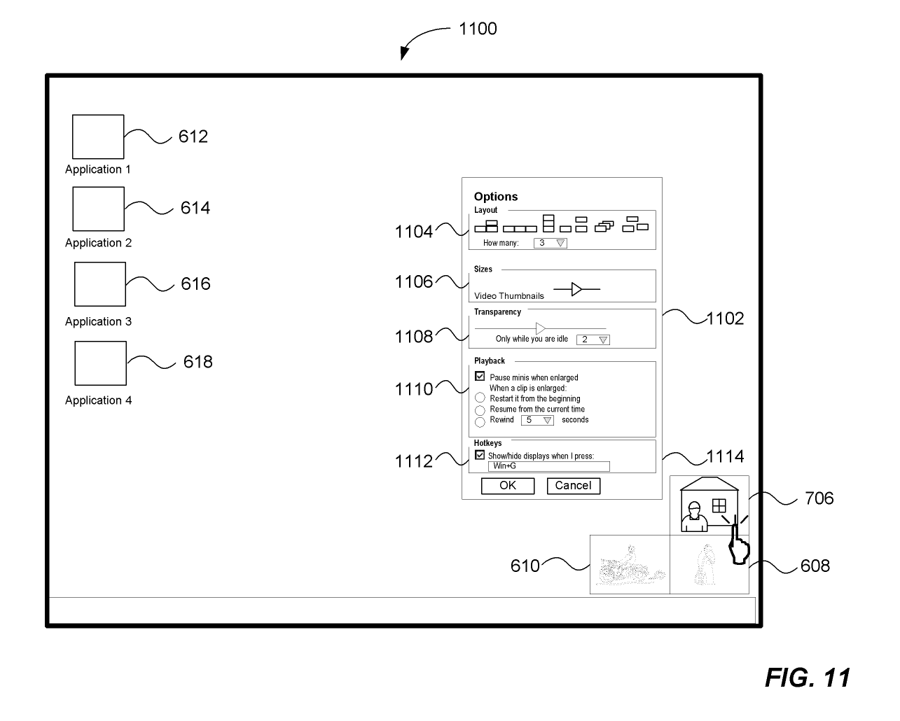

FIG. 11 depicts a screenshot of a user interface 1100 showing an options menu. An options menu 1102 can be provided upon a user selecting the options menu item 1016 as provided in menu 1004 of FIG. 10A. In another embodiment, the options menu 1102 can be displayed upon a user selecting any other user interface that permits a user to access the options menu 1102. For example, the video thumbnail 706 can include a small button on the video thumbnail that can be pressed for opening the options menu 1102.

The options menu 1102 can include one or more preference settings that a user can customize according to the user's liking. In one embodiment, a layout option 1104 can be included that permits a user to select the type of layout of the video thumbnails in addition to the number of video thumbnails that can be displayed. In one example, the video thumbnail layout includes a corner configuration that takes an approximate L-shape. In another example, a video thumbnail layout can be a horizontal stack wherein each of the video thumbnails is displayed adjacent to the other so as to form a horizontal bar. In another example, the video thumbnails are placed one next to the other so as to form a vertical bar. In another example, the video thumbnails can be arranged to be placed in the corners or equidistantly spaced on a side of the user interface 1100. In another example, the video thumbnails can be stacked on top of each other so that the video thumbnails are displayed one at a time in the same place on the user interface 1100. In yet another example, the video thumbnails are placed randomly on the screen.

In addition, the layout option 1104 can also permit a user to select how many video thumbnails are presented on the screen. For example, a user may select to have one, two, three, or more video thumbnails on the screen. In addition, the options menu 1102 can also include a size option 1106 that permits a user to select the size of each video thumbnail. In one embodiment, the user may select the size of a video thumbnail by selecting a slider user interface. In another embodiment, the user may select the size of the video thumbnails by selecting a number of pixels contained in the thumbnail (e.g. 64×48).

The size of the video thumbnails can also be set by other user interface mechanisms that do not include interfacing with the options menu 1102. For example, the video thumbnails can be resized by selecting a corner of the frame of the video thumbnails and dragging the corner until the desired size is achieved.

The options menu 1102 can further include a translucency option 1108 that permits a user to set the translucency of one or more video thumbnails according to a user selection. For example, the translucency option 1108 can include a transparency slider that permits a user to indicate the degree of transparency that can range from zero (opaque) to one hundred percent (transparent). In another example, the translucency option 1108 can include an opacity slider that permits a user to indicate the degree of opacity that can range from zero (transparent) to one hundred percent (opaque).

In addition, the translucency item 1108 can permit a user to select an option to maintain the video thumbnail in a translucent state only while the user is active on other applications at the computer device 102. For example, a check box can be provided to the options menu 1102 such that the user can check the check box to select that the video thumbnail be made translucent according to the selected degree of translucency when the user is working on other applications at the user computing device 102. In addition, an idle delay drop down menu can be provided as part of the options menu 1102 for the user to select the number of seconds that can be used to delay in transitioning from the translucency state to an opaque state when a user selects a video thumbnail or vice versa.

In an additional embodiment, the options menu 1102 can further include a playback item 1110 that provides the user with further configurable options. For example, the user may select a check box to indicate that other video thumbnails can be paused upon a video thumbnail being enlarged for viewing. For example, if the user selects video thumbnail 706 to be enlarged by double clicking on video thumbnail 706, the video playback of video thumbnails 706, 610 and 608 can be paused while the displayed video of the enlarged video thumbnail 706 is playing.

Other options provided on the playback option item 1110 can be, for example, to restart the displayed video when the video thumbnail is enlarged. For instance, upon a user double-clicking on the video thumbnail 706 and upon the video image being enlarged for viewing the user, the displayed video can be restarted from the beginning so that the user can view the entire video in which the user is interested. If the user is working on a word processing document and video thumbnails 706, 610 and 608 are presenting videos from one or more video sources, and video thumbnail 706 is displaying a news video clip, the user may select the content of video thumbnail 706 upon the user viewing an item or a video of interest. Then, if the user had selected to restart the displayed video in menu item 1110, the news video clip can restart so that the user can view the news report from the beginning. Of course, a displayed video can be easily restarted if the displayed video is a pre-recorded video clip. However, if the displayed video is not a prerecorded video clip, but instead, the displayed video is a live video stream, playing the video from the beginning would require that the live video stream be simultaneously recorded for later playback. For example, the live video can be buffered such that once the live video stream is finished the user can have access to the buffered video and view any portion of the buffered video.

In another example, if the displayed video is a pre-recorded video that is streamed to the computing device, the displayed video can be buffered and stored such that in the future, when the user requests the displayed video again, the pre-recorded video does not have to be streamed again.

In one embodiment, a hotkeys option 1112 can be provided to allow the user to enter shortcut keys assigned to a specific action. In one example, a user can provide a toggle shortcut key to hide/display all of the video thumbnails.

Finally, the options menu 1102 can provide other configurable items that a user can set to establish preferences for viewing one or more displayed videos.

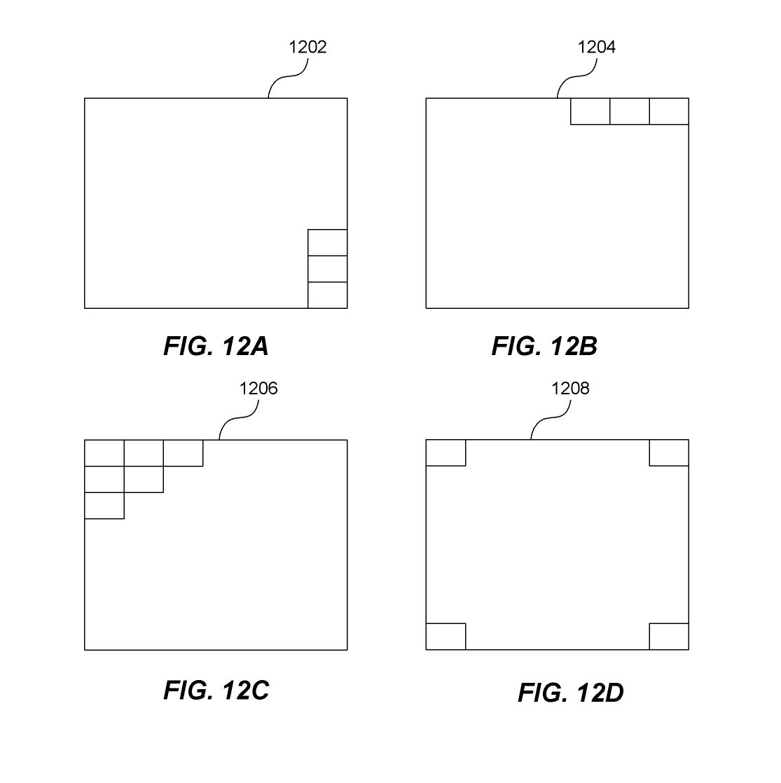

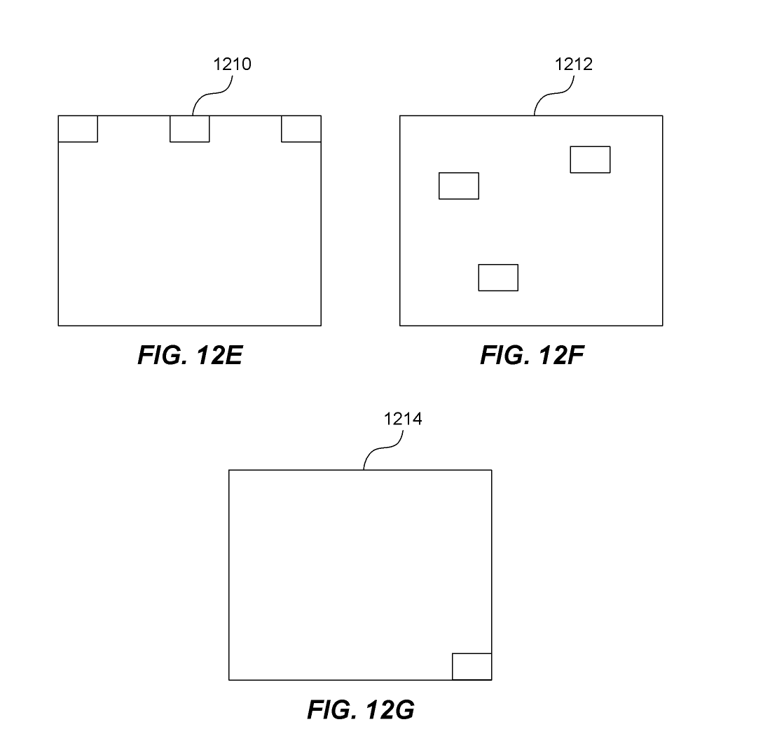

FIGS. 12A-12D depict configurations of video thumbnail layouts on the screen of a display. In one example, FIG. 12A depicts a video layout 1202 having a vertical stack of three video thumbnails on the bottom right hand corner. Of course, the vertical stack can be positioned in any corner of the screen, the middle of the left or right border of the screen, or any other area in the screen of the display 104. Additionally, the number of thumbnails can also be more or less than three video thumbnails. In another example, FIG. 12B depicts a video layout 1204 showing a horizontal stack on the upper right hand corner of the screen. The horizontal stack shown in the layout 1204 includes three video thumbnails positioned horizontally one next to another. Of course, the horizontal stack can be positioned in any corner of the screen, the middle of the top or bottom border of the screen, or any other area in the screen of the display 104. Additionally, the number of thumbnails can also vary. In another example, FIG. 12C depicts a layout 1206 that includes six video thumbnails on the upper left hand corner as a corner arrangement. Again, the number of video thumbnails as well as the corner of the screen in which the video thumbnails are placed can also vary. In another example depicted by FIG. 12D, a video layout 1208 can permit a user to configure video thumbnails to be displayed on each of the corners of the screen. As such, video layout 1208 can be configured to place video thumbnails on one or more corners of the screen of the display 104.

In another example depicted by FIG. 12E, a user can configure video thumbnails to be displayed across one of the borders of the screen and equally spaced from each other. Thus, for example, in layout 1210 the video thumbnails are displayed across the top border of the screen and equally spaced. Of course the video thumbnails can be displayed along any of the borders of the screen. For example, the video thumbnails can be displayed across the bottom border, the left border, or the right border of the screen. Also, the number of video thumbnails displayed can also vary.

In another example depicted by FIG. 12F, a video layout 1212 can permit a user to configure video thumbnails to be displayed randomly on the screen. In one embodiment, the user can drag and drop the video thumbnails on different locations of the screen. In another embodiment, the user can simply select that the video thumbnails be placed randomly on the screen.

In another example depicted by FIG. 12G, a video layout 1214 can permit a user to configure video thumbnails to be displayed one top of another on the screen. Thus, for example, three video signals can be simultaneously received, but one is displayed at a time. Therefore, the portion of the screen occupied would be that of a single video thumbnail although multiple video signals are being received. In one example, the display on the video thumbnail is sequential, such that all of the video signals are displayed for a short period of time one after another. For instance, if three video signals are being rendered, the first one can be displayed for five seconds, then the second one can be displayed for five seconds, then the third one can be displayed for five seconds, then the first one can be displayed for five seconds, and so on.

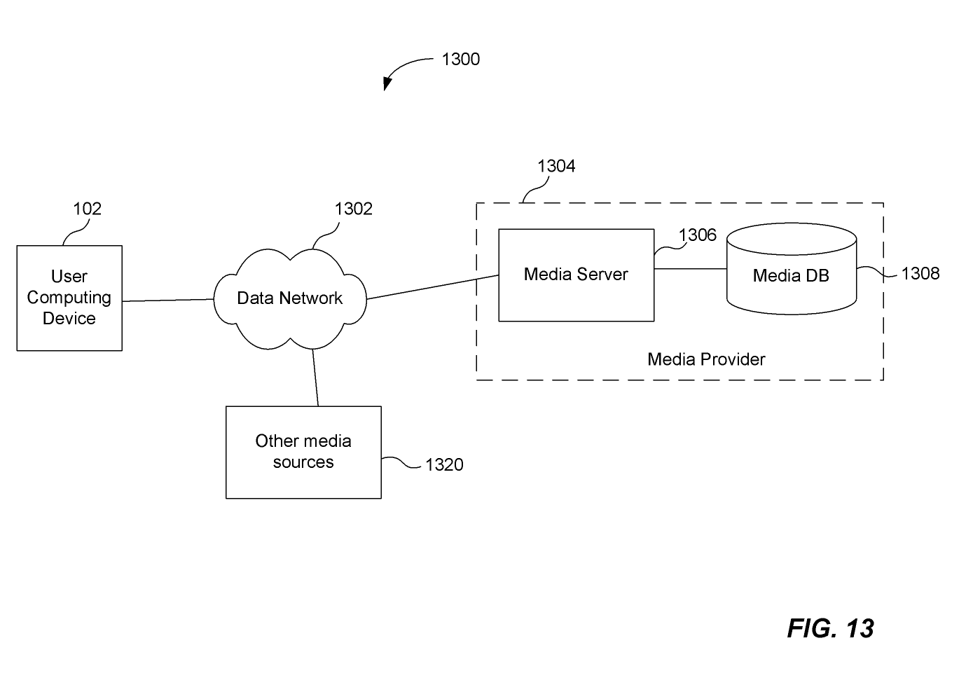

FIG. 13 depicts a networked system for presenting video. A client/server system 1300 can be utilized to implement the methods described herein. A user computing device 102 can be utilized to receive a video stream or other format of video that can be communicated over a data network 1302 from a media provider 1304, or other media sources 1320. As previously mentioned, the computing device 102 can receive video signals from one or more video sources. In one embodiment, the video source can be a media provider 1304 that streams video signals via a data network 1302 to the computing device 102. In another embodiment, the video source can be a media provider 1304 that retrieves video signals via the data network 1302 and thereafter transmits the video signals to the computing device 102.

In one embodiment, the data network 1302 can be the Internet. In another embodiment, the data network can be an intranet. In alternate embodiments, the data network 1302 can be a wireless network, a cable network, a satellite network, or any other architecture now known or to become known by which media can be communicated to a user computing device.

The media provider 1304 can include a media server 1306 and a media database 1308. In one embodiment, the media database 1308 can be a repository or a mass storage device that stores data or video or any other media that can be retrieved by the media server 1306. In another embodiment, the media database 1308 can contain pointers indicating where media may be found at other media sources 1320.

The media server 1306 can be configured to transmit the retrieved video from the media database 1308 and submit the retrieved video through the data network 1302 to the computing device 102. The media database 1308 can include prerecorded video that has been stored by the media server 1306 upon a storage command from one or more entities. For example, the user can request the storage of a video on the media database 1308 by submitting the video to the media server 1306 for storage.

In another embodiment, the media database 1308 includes prerecorded video that has been produced by the media provider 1304 and that can be provided to the user through the computing device 102. In yet another embodiment, the media database 1308 can include, by way of non-limiting example, video that has been submitted to the media provider 1304 for distribution to users through the Internet. Additionally, the media server 1306, or other server or processor, can also be configured to stream, or otherwise broadcast, video from a live event so that the user at the user computing device 102 can watch a live video as the event occurs. For example, the media server 1306 can be configured to receive a video signal of a football game. The video signal can then be transmitted through the Internet as a web cast and received at the computing device 102. Furthermore, the media server 1306 can be configured to transmit two or more video signals to the computing device 102 simultaneously. For example, the media server 1306 can retrieve two video clips from the media database 1308 and stream the two video clips through the data network 1302 to the computing device 102. As previously discussed, the computing device 102 can be configured to display two or more video clips simultaneously in a video window or video thumbnails.

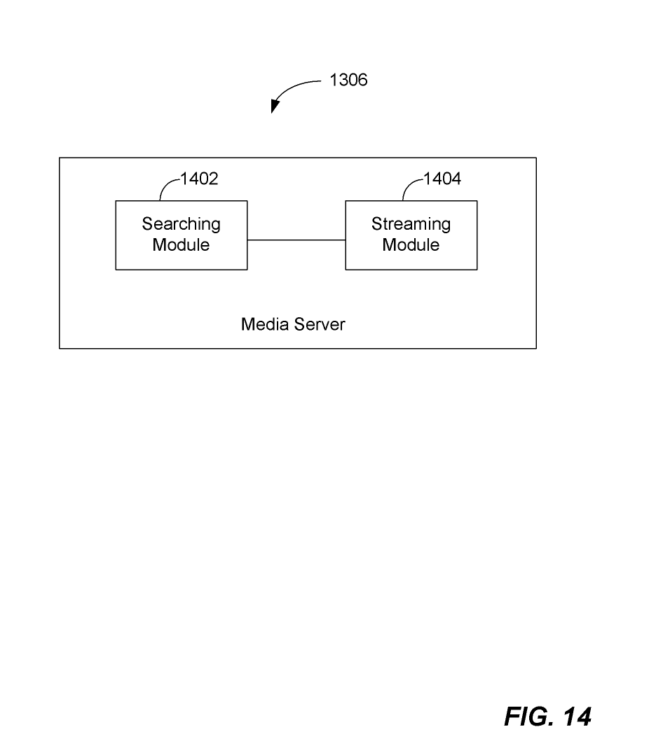

FIG. 14 depicts a component diagram of one embodiment of a media server. In one embodiment, the media server 1306 can include a searching module 1402 and a streaming module 1404. The searching module 1402 can be configured with logic to receive query instructions from a user through a data network 1302 and retrieve relevant video clips or files from the media database 1308. For example, a user that is searching for a video that is relevant to a sport event can enter a query at the computing device 102. The query can then be received at the media server 1306 and processed at the searching module 1402. Using known techniques and algorithms for searching, the searching module 1402 can search in the media database 1308 to retrieve video clips relevant to user's search. Furthermore, the searching module 1402 can also be configured with logic to search in other media sources 1320 through the data network 1302.

In addition, the media server 1306 can also include a streaming module 1404 that can be configured with logic to receive the retrieved media clips clip from a searching module 1402 and send data packets over the data network 1302 to the computing device 102. In addition, the streaming module 1404 can also be configured to transcode any format of video, including live video, into data packets for transmitting to the computing device 102. In a further embodiment, the media server 1306 can be configured with logic to transmit to the computing device 1402 video signals received from other media sources 1320 through the data network 1302. The media server can further include other functionalities such as downloading, transcoding, digital rights management, playlist management, etc.

Many applications of the systems and methods described herein are contemplated. For example, this system can be utilized for security systems such as home or business security, surveillance systems, process monitoring, etc. Also, this system can be utilized as a collaboration tool, displaying several members of a group engaged in a common task, such as working on a business project or playing a turn-based game. In addition, this system can be utilized for information acquisition such as news monitoring, financial market events monitoring, match and sport updated scores reporting, etc. Furthermore, this system can be utilized for education and training, such as displaying webcast lectures and seminars. Moreover, this system can be utilized for entertainment such as displaying of TV and movie trailers, music videos, photo slideshows, TV shows, movies, live events, etc.

The video presented to a user as described herein, can be presented in the form of video thumbnails, a player window, or any other form of visual display that can render digital video.

The displayed video can be of multiple formats. For example, the displayed video can be any dynamic visual media, including animations, prerecorded video clips, live video streams, webcasts, podcasts, vlogs, etc.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

1. A method of presenting video on a display having a visible display area, comprising:
receiving for display a first video input from a first video source;
receiving for display a second video input from a second video source;
displaying a first video corresponding to the first video input in a first viewing region of the display, the first viewing region being of a size that occupies a fractional portion of the visible display area; and
displaying a second video corresponding to the second video input in a second viewing region of the display, the second viewing region being of a size that occupies a fractional portion of the visible display area, the first video and the second video, when displayed in the viewing regions, being displayed in a translucent fashion so that both the first video and the second video are visible, and so that other content displayed on the computer display is visible through the first video and the second video.

2. The method of claim 1, wherein the degree of translucency is adjustable.

3. The method of claim 2, further comprising receiving a command to minimize the degree of translucency to opaque.

4. The method of claim 2, further comprising receiving a command to maximize the degree of translucency to transparent.

5. The method of claim 1, wherein the first viewing region is a video thumbnail and the second viewing region is a video thumbnail.

6. The method of claim 1, wherein the first video source is a server configured to transmit video signals over a computer network.

7. The method of claim 1, wherein the second video source is a server configured to transmit video signals over a computer network.

8. The method of claim 1, further comprising enlarging the first video viewing region upon receiving a selection of the first viewing region from the user.

9. The method of claim 1, further comprising:
extracting metadata from the first video signal; and
executing a command if the metadata matches a criterion associated with the user.

10. The method of claim 9, wherein the metadata comprises closed caption data.

11. The method of claim 10, further comprising displaying the closed caption data in a separate user interface display.

12. The method of claim 9, wherein the command comprises enlarging the first viewing region.

13. The method of claim 9, wherein the command comprises increasing the volume of an audio portion associated with the first video signal.

14. The method of claim 9, wherein extracting metadata from the first video signal comprises recognizing text embedded in a video image associated with the first video signal.

15. The method of claim 14, further comprising displaying the recognized text in a separate user interface display.

16. The method of claim 9, wherein extracting metadata from the first video signal comprises recognizing audio associated with the first video signal.

17. The method of claim 1, further comprising:
determining whether a change in volume in the audio associated with the first video signal has occurred; and
executing a command if the metadata matches a criterion associated with the user.

18. The method of claim 17, wherein the command comprises enlarging the first viewing region.

19. The method of claim 1, further comprising:
determining whether a change in scene associated with the first video signal has occurred; and
executing a command if the metadata matches a criterion associated with the user.

20. The method of claim 19, wherein the command comprises enlarging the first viewing region.

21. The method of claim 1, further comprising displaying information related to the first video input upon a user hovering over the first viewing region.

22. The method of claim 1, further comprising displaying a playback operation user interface in relation to the first video input upon a user hovering over the first viewing region.

23. The method of claim 1, wherein the first video input is live video or a prerecorded video.

24. The method of claim 1, wherein the second video input is live video or a prerecorded video.

25. The method of claim 1, wherein other content displayed on the computer display includes a graphical user interface.

26. A system that presents video on a display a having a visible display area, comprising:
a computing device that receives a first video input from a first video source, the computing device further receiving a second video input from a second video source; and
a display that displays a first video corresponding to the first video input, the first video being displayed in a first viewing region, the first viewing region being of a size that occupies a fractional portion of the visible display area, the display being further configured to display a second video corresponding to the second video input, the second video being displayed in a second viewing region, the second viewing region being of a size that occupies a fractional portion of the visible display area, the first video and the second video, when displayed in the viewing regions, being displayed in a translucent fashion so that both the first video and the second video are visible, wherein other content displayed on the display is visible through the first video and the second video.

27. The system of claim 26, wherein the degree of translucency can be minimized to non-opaque.

28. The system of claim 26, wherein the degree of translucency can be maximized to transparent.

29. The system of claim 26, wherein the first viewing region is a video thumbnail and the second viewing region is a video thumbnail.

30. The system of claim 26, further comprising a closed caption recognition module that is configured to extract closed caption data from the first video signal and execute a command if the closed caption data matches a criterion associated with the user.

31. A user interface for presenting video on a display, comprising:
a visible display area configured to display user interface elements; and
a video thumbnail being displayed on the visible display area, the video thumbnail displaying video with a first degree of translucency when the user does not interact with the video thumbnail such that the first degree of translucency permits other user interface elements to be visible through the video thumbnail, the video thumbnail displaying video with a second degree of translucency when the user interacts with the video thumbnail, the first degree of translucency being higher in translucency than the second degree of translucency.

32. The user interface of claim 31, wherein the video thumbnail is borderless.

33. The user interface of claim 31, wherein the video thumbnail is displayed at the periphery of the visible display area.

34. The user interface of claim 31, wherein the video thumbnail displays the video with an increased audio when the user hovers over the video thumbnail.

35. The user interface of claim 31, wherein the video thumbnail displays the video with data associated to the video when the user hovers over the video thumbnail.

36. The user interface of claim 31, wherein the video thumbnail displays a toolbar to control video playback of the video when the user hovers over the video thumbnail.

37. The user interface of claim 31, wherein the video thumbnail changes in size when the user interacts with the video thumbnail.

38. The user interface of claim 31, further comprising a second video thumbnail being displayed on the visible display area, the second video thumbnail displaying video with the first degree of translucency when the user does not interact with the adjacent video thumbnail, the second video thumbnail displaying video with the second degree of translucency when the user interacts with the video thumbnail.

39. The user interface of claim 31, wherein after a predetermined amount of time of user inactivity, the video thumbnail is automatically rendered opaque.

40. The user interface of claim 31, wherein a universal resource locator can be dragged onto the video thumbnail to display video associated to the universal resource locator in the video thumbnail.

41. The user interface of claim 31, wherein a file icon can be dragged onto the video thumbnail to display video associated to the file icon in the video thumbnail.

42. A method of presenting video on a display a having a visible display area, comprising:
receiving for display a video input from a video source; and
displaying a video corresponding to the video input in a viewing region of the display, the viewing region being of a size that occupies a fractional portion of the visible display area, the video being displayed in a translucent fashion so that the video is visible and so that other content displayed on the computer display is visible through the video.

43. The method of claim 42, wherein the degree of translucency is adjustable.

44. The method of claim 42, wherein the viewing region is a video thumbnail.

45. The method of claim 42, wherein the video source is a media server configured to transmit video signals over a computer network.

46. A method of presenting video on a display a having a visible display area, comprising:
receiving for display a video input signal from a video source;
displaying a video corresponding to the video input in a viewing region of the display, the viewing region being of a size that occupies a fractional portion of the visible display area;
extracting metadata associated with the video input signal; and
executing a command if the metadata matches a criterion received from a user.
